(19) United States
(12) Patent Application Publication
(10) Pub. No.: US 2024/0264870 A1
(43) Pub. Date: Aug. 8, 2024

(54) METHODS AND SYSTEMS FOR PERFORMING SERVICE VERIFICATION ON A PLURALITY OF PARTIES IN FEDERATED COMPUTATION BASED ON CONTAINER CLUSTER

(71) Applicant: Alipay (Hangzhou) Information Technology Co., Ltd., Hangzhou (CN)

(72) Inventors: Ting Cheng WU, Hangzhou (CN); Chang Yu YANG, Hangzhou (CN)

(21) Appl. No.: 18/565,437

(22) PCT Filed: Jul. 12, 2022
(86) PCT No.: PCT/CN2022/105055

§ 371 Date: Nov. 29, 2023

(30) Foreign Application Priority Data
Aug. 10, 2021 (CN) 202110914347.7

(51) Int. Cl. G06F 9/50

(52) U.S. Cl. CPC G06F 9/5027

(57) ABSTRACT

Embodiments of this specification provide a method and a system for performing service verification on a plurality of parties in federated computation based on a container cluster. In the verification method, a verification management center sends a task establishment request to a master node in response to a service verification request of a user, where the task establishment request indicates at least a target service that is to be verified and that is used by a target participant. The master node creates a verification task of the target service for a target slave node in the target participant based on the task establishment request. The target slave node verifies a target service of the target participant in response to the verification task, to obtain a service verification result. The target slave node provides the service verification result for the verification management center.

This specification claims priority to Chinese Patent Application No. 202110914347.7, filed with the China National Intellectual Property Administration on Aug. 10, 2021 and entitled “METHODS AND SYSTEMS FOR PERFORMING SERVICE VERIFICATION ON A PLURALITY OF PARTIES IN FEDERATED COMPUTATION BASED ON CONTAINER CLUSTER”, which is incorporated here by reference in its entirety.

### TECHNICAL FIELD

One or more embodiments of this specification relate to the field of computer technologies, and in particular, to methods and systems for performing service verification on a plurality of parties in federated computation based on a container cluster.

### BACKGROUND

To facilitate data management, a plurality of participants in federated computation generally separately deploy target services respectively corresponding to the participants for data respectively held by the participants. The target service here includes at least one of a storage service, an audit service, and a preprocessing service of local feature data.

It is worthwhile to note that, correctness of a federated computation result can be ensured only when the above-mentioned target service can be correctly invoked. Therefore, a solution for performing correctness verification for the target service needs to be provided.

### SUMMARY

One or more embodiments of this specification describe methods and systems for performing service verification on a plurality of parties in federated computation based on a container cluster, so that correctness of a target service can be verified by using a task management capability of the container cluster, to reduce service verification costs.

According to a first aspect, a method for performing service verification on a plurality of parties in federated computation based on a container cluster is provided, including:
sending, by a verification management center, a task establishment request to the master node in response to a service verification request of a user, where the task establishment request indicates at least a target service that is to be verified and that is used by a target participant;
creating, by the master node, a verification task of the target service for a target slave node in the target participant based on the task establishment request;
verifying, by the target slave node, a target service of the target participant in response to the verification task, to obtain a service verification result; and
providing, by the target slave node, the service verification result for the verification management center.

According to a second aspect, a system for performing service verification on a plurality of parties in federated computation based on a container cluster is provided, including:
the verification management center is configured to send a task establishment request to the master node in response to a service verification request of a user, where the task establishment request indicates at least a target service that is to be verified and that is used by a target participant;
the master node is configured to create a verification task of the target service for a target slave node in the target participant based on the task establishment request;
the target slave node is configured to verify a target service of the target participant in response to the verification task, to obtain a service verification result; and
the target slave node is further configured to provide the service verification result for the verification management center.

According to a third aspect, a computer storage medium is provided, where the computer storage medium stores a computer program, and when the computer program is executed in a computer, the computer is enabled to perform the method according to the first aspect.

According to a fourth aspect, a computing device is provided, including a memory and a processor, where the memory stores executable code, and when executing the executable code, the processor implements the method according to the first aspect.

According to the method for performing service verification on a plurality of parties in federated computation based on a container cluster provided in one or more embodiments of this specification, correctness of a target service can be verified by using a task management capability of the container cluster, so that a problem that maintenance costs are increased by directly constructing a service verification task and maintaining and managing the task in real time is avoided. In addition, in this solution, a corresponding target service is locally verified at each party, so that security of data of each party can be ensured.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can still derive other drawings from these accompanying drawings without creative efforts.

FIG. 1 is a schematic diagram illustrating a container cluster, according to this specification;

FIG. 2 is a schematic diagram illustrating an implementation scenario, according to an embodiment of this specification;

FIG. 3 is an interaction diagram illustrating a method for performing service verification on a plurality of parties in federated computation based on a container cluster, according to an embodiment of this specification;

FIG. 4 is a diagram illustrating a state change of a verification task, according to this specification; and

FIG. 5 is a schematic diagram illustrating a system for performing service verification on a plurality of parties in federated computation based on a container cluster, according to an embodiment of this specification.

### DESCRIPTION OF EMBODIMENTS

The solutions provided in this specification are described below with reference to the accompanying drawings.

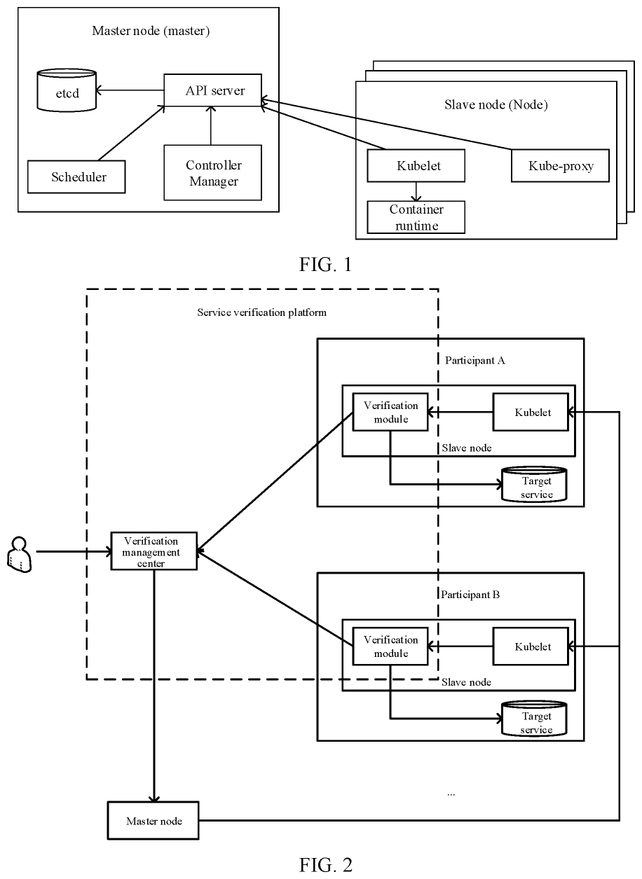

FIG. 1 is a schematic diagram illustrating a container cluster, according to this specification. The container cluster can be managed by Kubernetes (k8s) (a container orchestration tool), and therefore the container cluster can also be referred to as a k8s container cluster. In FIG. 1, the container cluster can include a master node and several slave nodes.

The following components can run in the master node: API Server, Scheduler, Controller Manager, and etcd. API Server is mainly responsible for communicating with another component or the slave node. Scheduler is used to schedule a task (i.e., assign a machine). Controller Manager is used to perform cluster-level functions, such as replicating components, continuously tracking working nodes, and processing node failures. etcd is a reliable distributed data store that can persistently store cluster configurations. In conclusion, the master node holds and controls a cluster state, but no containerized application (i.e., an application running in the container) runs in the master node, and running of the containerized application is completed by the slave node.

At least the following components can run on the above-mentioned slave node: Kubelet, Docker, kube-proxy, and Pod. Pod is a most basic operation unit in Kubernetes. One Pod represents one process running in the cluster, and internally encapsulates one or more closely related containers. Kubelet (referred to as a container management component) can communicate with API server, and is used to listen for tasks assigned to the present node. Docker is a container engine used to pull a container image from an image repository and run the container. kube-proxy is responsible for load balancing between nodes. The first three components in the above-mentioned components can be used to manage (for example, create pod or destruct pod) the lifecycle of Pod on the present node.

As described above, a containerized application can run in the slave node. The following briefly describes a deployment process of the containerized application.

First, an application to be deployed can be packaged into one or more container images. Then, the container images can be pushed to the image repository, and description information of the container images can be published to API server. In an example, the description information here can include, for example, a running condition of the container image, for example, the container image runs by using a specified slave node.

API server can process the container images one by one. Specifically, Scheduler can be invoked to assign corresponding slave node to the container images based on a current resource allocation status and the description information. Then, when Kubelet in a corresponding slave node monitors the assigned task, Docker is used to pull the container images from the image repository and run the container images, so that deployment of the containerized application is completed.

It can be learned from the above-mentioned content that the container cluster has an automatic task management capability. In the solution provided in the embodiments of this specification, service verification is performed on a plurality of participants (referred to as a plurality of parties in federated computation) in federated computation by using the task management capability of the container cluster. A reason for using the container cluster is described later. The following first describes federated computation.

In a big data era, a plurality of parties can hold data of a same object. In this case, when data computation is performed on the data of the object, a plurality of participants are involved, and the plurality of participants may need to cooperate to complete the data computation. However, due to competition or privacy protection, different participants cannot or are not willing to leak data held by the participants.

For example, the same natural person can borrow money on different peer-to-peer (P2P) platforms. Therefore, each P2P platform can store a borrowing amount of the natural person on the platform. When a total borrowing amount of the natural person on a plurality of P2P platforms needs to be counted, data on the plurality of P2P platforms often needs to be combined to complete the statistical computation. In this example, the P2P platform is a participant, the borrowing amount of the natural person is data held by the participant, and computation of the total borrowing amount of the natural person data is data computation expected to be completed.

For another example, each bicycle-sharing platform can provide a bicycle use service for a user. Each bicycle-sharing platform stores a daily use quantity of shared bicycles on the platform. When it is expected to count a total use quantity of shared bicycles in a certain day, data on a plurality of bicycle-sharing platforms often needs to be combined to complete statistical computation. In this example, the bicycle-sharing platform is a participant, the use quantity of shared bicycles in this day is data held by the participant, and computation of the total use quantity of shared bicycles in this day is data computation expected to be completed.

For another example, each e-commerce platform may store consumption data of a same consumer group or different consumer groups. To facilitate a better understanding of consumer habits and select target groups for marketing campaigns, consumption data on a plurality of e-commerce platforms often needs to be combined for model training. In this example, the e-commerce platform is a participant, the consumption data recorded by the e-commerce platform is data held by the participant, and the model training performed by using the data is data computation expected to be completed.

It can be learned from the above-mentioned content that, in most cases, data of parties participating in federated computation is generally kept confidential from each other. A target service is deployed for data of each participant. Therefore, for a target service of any participant, neither a participant other than the participant nor a third party can directly invoke the target service. Therefore, this specification proposes that a target service of each participant is locally verified at the participant, and then only one piece of result information (also referred to as a result state) indicating a success or a failure is returned, to ensure security of data of each participant.

However, when there is a large quantity of participants, a corresponding verification task needs to be created for a participant of each service to be verified, and a corresponding result state needs to be managed and maintained. As a result, maintenance costs are increased. Therefore, this solution proposes to perform service verification on a plurality of participants in federated computation by using a task management capability of a container cluster. The following describes this solution.

FIG. 2 is a schematic diagram illustrating an implementation scenario, according to an embodiment of this specification. In FIG. 2, each participant can be implemented as any device, platform, server, or device cluster with computation and processing capabilities. It is worthwhile to note that, to use a task management capability of a container cluster, a slave node in the container cluster can be deployed in each participant.

In FIG. 2, each participant is deployed with a corresponding target service. The target service here includes at least one of a storage service, an audit service, and a preprocessing service of local feature data. For example, federated computation is secure multi-party computation (MPC) to jointly perform service prediction. The above-mentioned target service can include at least one of a storage service, an audit service, and a preprocessing service of local feature data used to perform service prediction.

For a target service of any participant, the target service can be verified by using a service verification platform. The service verification platform can include a verification management center and several verification modules. Each verification module is pre-deployed in a slave node of each participant. The verification module here can be understood as a containerized application. For a specific deployment process of the containerized application, references can be made to the descriptions above. In addition, the service verification platform can further include a user interface. The following describes a specific verification process:

The verification management center sends a task establishment request to a master node in a container cluster in response to a service verification request of a user. The task establishment request indicates at least a target service that is to be verified and that is used by a target participant. The master node creates a verification task of the target service for a target slave node in the target participant based on the task establishment request. A container management component (kubelet) in the target slave node listens for a verification task assigned to the target slave node, and when obtaining the verification task through listening, performs verification on the target service of the target participant by using a verification module, to obtain a service verification result. The target slave node provides the service verification result for the verification management center.

That is, in the solution provided in this specification, service verification processes of a plurality of participants in federated computation can be uniformly managed.

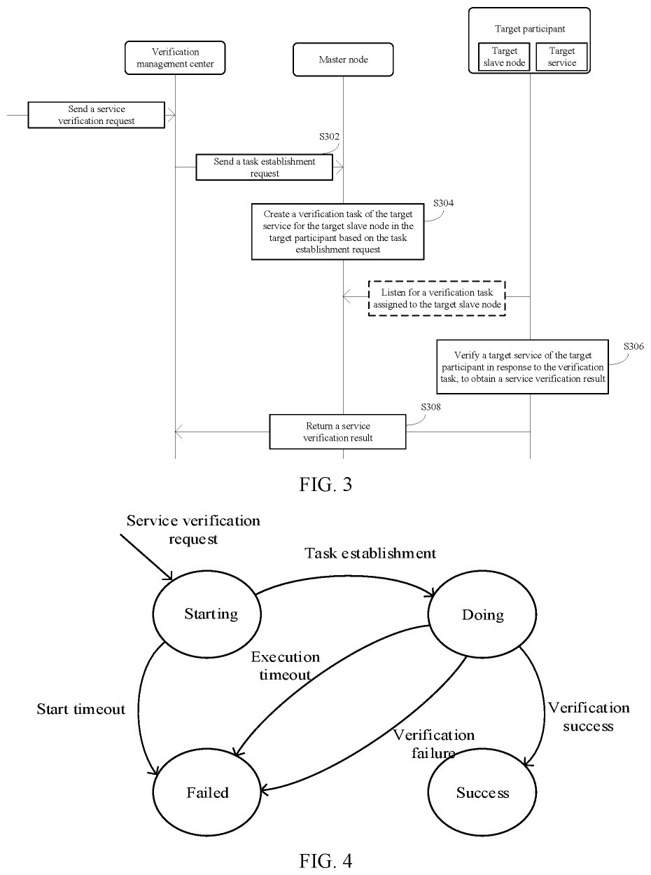

FIG. 3 is an interaction diagram illustrating a method for performing service verification on a plurality of parties in federated computation based on a container cluster, according to an embodiment of this specification. As shown in FIG. 3, the method can include the following steps:

Step 302: The verification management center sends a task establishment request to a master node in response to a service verification request of a user.

Optionally, a user interface can be first displayed to the user, so that the user can fill in, in the user interface, description information of a target service that is to be verified and that is used by a target participant. For example, a namespace of the target participant, a unique identifier of data to be verified, and several field names can be filled in. The data to be verified here can be data of the target service that is to be verified and that is used by the target participant, and can include a plurality of fields. It should be understood that the above-mentioned several field names can be names of at least a part fields in the plurality of fields included in the data to be verified. For example, the participant is a bank institution. The data to be verified here can refer to a borrowing record of a borrowing user. The borrowing record can include the following fields: a borrowing date, a borrowing amount, a payment date, a borrower, etc.

Then, when the user interface receives an instruction used to indicate that filling of the description information is completed, the user interface can send the service verification request to the verification management center, so that the verification management center sends the task establishment request to the master node.

It should be understood that the task establishment request here indicates at least the target service that is to be verified and that is used by the target participant. In addition, the task establishment request can further indicate information such as a unique identifier of data to be verified and several field names.

Optionally, after sending the above-mentioned task establishment request, the verification management center can initialize a state of a verification task. For example, the verification management center can initialize the state to: Starting.

Step 304: The master node creates a verification task of the target service for a target slave node in the target participant based on the task establishment request.

In step 304, after creating the verification task, the master node can further add the unique identifier of the data to be verified to a configuration parameter of the verification task as a verification basis, so that the target slave node uses the unique identifier when executing the verification task. Certainly, in actual practice, if the task establishment request further indicates several field names, the unique identifier of the data to be verified and the field names can be added to a configuration parameter of the verification task as a verification basis.

It is worthwhile to note that, for the verification task of the target service, the Scheduler component in the master node can schedule the verification task to the target slave node in the target participant based on the task establishment request. Therefore, the verification task for the target slave node in the target participant is created.

Step 306: The target slave node verifies a target service of the target participant in response to the verification task, to obtain a service verification result.

As described above, the Kubelet component in the slave node in the container cluster monitors tasks assigned to the slave node. For example, the Kubelet component periodically checks whether a task assigned to the slave node exists in the master node. If yes, and the task is the verification task of the target service, a verification module in the slave node is started by using Docker, to execute the verification task of the target service. Certainly, if the verification task has a corresponding configuration parameter, the configuration parameter can be further transmitted to the verification module by using Docker, so that the verification module executes the verification task of the target service based on the configuration parameter.

Optionally, after the verification module in the target node starts to execute the verification task, that is, after the verification module starts to verify the target service, the verification module can send a task start notification to the verification management center. Therefore, the verification management center can update the initialized task state to obtain an intermediate state. For example, the intermediate state can be represented as: Doing.

In step 306, the target slave node can specifically execute the verification task for the target service based on the configuration parameter. Specifically, the target slave node can invoke an interface of the target service of the target participant based on the unique identifier of the data to be verified and the several field names, to obtain a verification result of the data to be verified. If the verification result satisfies a predetermined condition, the target slave node determines that the service verification result is a verification success.

In an example, the verification result can include a quantity of fields included in the data to be verified and/or data types of at least a part of fields. It should be understood that the at least a part of fields here can be fields corresponding to the above-mentioned several field names. Correspondingly, the above-mentioned predetermined condition can include a predetermined quantity, several predetermined types, etc. That is, that the verification result satisfies the predetermined condition can mean that the quantity of fields included in the data to be verified matches the predetermined quantity and/or the data types of the fields match the predetermined types.

It should be understood that the verifying a target service of the target participant can further include: if the invoking of the interface of the target service of the target participant fails, determining that the service verification result is a verification failure. Alternatively, if the verification result does not satisfy the predetermined condition, the target slave node determines that the service verification result is a verification failure.

Step 308: The target slave node provides the service verification result for the verification management center.

As described above, the service verification result here can include a verification success or a verification failure. Specifically, if the received service verification result is a verification success, the verification management center can update the above-mentioned initialized task state or intermediate state to: Success. If the received service verification result is a verification failure, the verification management center can update the above-mentioned initialized task state or intermediate state to: Failed.

Certainly, in actual practice, if determining that the service verification result is not received after timeout time threshold is reached, the verification management center updates the task state to: Failed.

It should be understood that, based on the task state maintained by the verification management center, correctness of the target service of the participant can be quickly learned of.

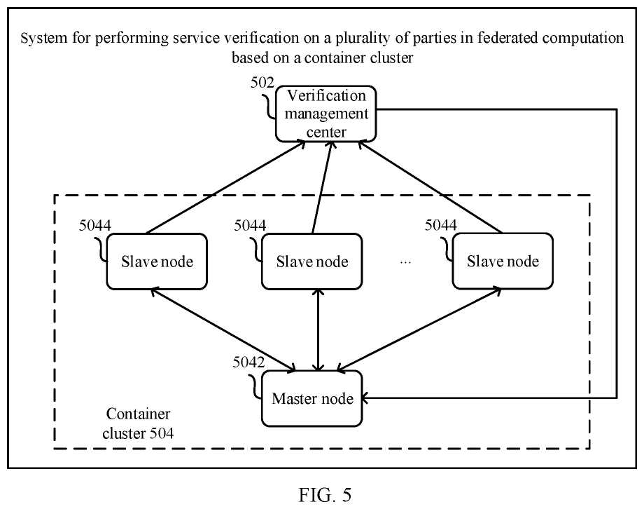

FIG. 4 is a diagram illustrating a state change of a verification task, according to this specification. In FIG. 5, after sending the task establishment request to the master node in the container cluster, the verification management center can initialize the task state of the verification task to: Starting. Then, if starting of the verification module in the target slave node fails (or referred to as a start timeout), the verification management center directly updates the task state to: Failed. If starting of the verification module in the target slave node succeeds, after the verification module starts to execute the verification task of the target service, that is, after the task is established, based on the received task start notification, the verification management center can update the task state to: Doing. Then, if the service verification result received by the verification management center is a verification success, the verification management center updates the task state to: Success. If the service verification result received by the verification management center is a verification failure, the verification management center updates the task state to: Failed. Certainly, after execution of the verification task is completed, if the verification management center does not receive the service verification result after the timeout time threshold (that is, an execution timeout) is reached because the verification module cannot establish a normal network connection to the verification management center, the verification management center updates the task state to: Failed.

In conclusion, in the solution provided in one or more embodiments of this specification, a set of loosely coupled service verification pipelines are constructed when the target service is verified by using the task management capability of the container cluster. The service verification pipeline is initiated unidirectionally, and after the pipeline is initiated, the verification module in the service verification pipeline automatically reports a service verification result after service verification. Therefore, a problem that maintenance costs are increased by directly constructing a service verification task and maintaining and managing the task in real time can be avoided. In addition, the verification module is deployed in the slave node of the participant. Therefore, a corresponding target service can be locally verified at each participant, and after the local verification, the verification module transmits only a strictly controlled verification result (that is, a verification success or failure), so that security of data of each participant can be ensured.

Corresponding to the above-mentioned method for performing service verification on a plurality of parties in federated computation based on a container cluster, an embodiment of this specification further provides a system for performing service verification on a plurality of parties in federated computation based on a container cluster. As shown in FIG. 5, the system includes a verification management center 502 and a container cluster 504. The container cluster includes a master node 5042 and a plurality of slave nodes 5044 respectively deployed in a plurality of participants.

The verification management center 502 is configured to send a task establishment request to the master node in response to a service verification request of a user, where the task establishment request indicates at least a target service that is to be verified and that is used by a target participant.

The above-mentioned target service includes at least one of a storage service, an audit service, and a preprocessing service of local feature data.

The master node 5042 is configured to create a verification task of the target service for a target slave node in the target participant based on the task establishment request.

The task establishment request indicates at least a unique identifier of data to be verified.

The master node 5042 is specifically configured to:
add the unique identifier of the data to be verified to a configuration parameter of the verification task as a verification basis.

The target slave node 5044 is configured to verify a target service of the target participant in response to the verification task, to obtain a service verification result.

The target slave node 5044 is specifically configured to:
listen for the verification task by using a container management component, and when obtaining the verification task through listening, start a verification module in the target slave node, and verify the target service by using the verification module.

The target slave node 5044 is further specifically configured to:
invoke an interface of the target service by using the verification module, to obtain a verification result of the data to be verified; and
if the verification result satisfies a predetermined condition, determine that the service verification result is a verification success.

The verification result includes a quantity of fields included in the data to be verified and/or data types of at least a part of fields.

The target slave node 5044 is further configured to provide the service verification result for the verification management center 502.

Optionally, the verification management center 502 is further configured to: if the invoking of the interface of the target service fails, determine that the service verification result is a verification failure; or
if the verification result does not satisfy a predetermined condition, determine that the service verification result is a verification failure.

Optionally, the verification management center 502 is further configured to initialize a task state of the verification task; and

The verification management center 502 is further configured to update the task state based on the service verification result after receiving the service verification result.

Optionally, the verification management center 502 is further configured to receive a task start notification sent by the target slave node 5044 after starting to verify the target service.

The verification management center 502 is further configured to update the initialized task state based on the task start notification to obtain an intermediate state.

The verification management center 502 is specifically configured to:
update the intermediate state based on the service verification result.

Optionally, the verification management center 502 is further configured to: if determining that the service verification result is not received after a timeout time threshold is reached, update the task state to a failure.

The functions of the functional modules of the apparatus in the above-mentioned embodiments of this specification can be implemented by performing the steps in the above-mentioned method embodiments. Therefore, a specific working process of the apparatus provided in the embodiments of this specification is omitted here for simplicity.

According to the system for performing service verification on a plurality of parties in federated computation based on a container cluster provided in an embodiment of this specification, a target service of each party can be verified when data security of each party is ensured.

According to an embodiment of another aspect, a computer-readable storage medium is further provided, where the computer-readable storage medium stores a computer program, and when the computer program is executed in a computer, the computer is enabled to perform the method described with reference to FIG. 2 or FIG. 3.

According to an embodiment of still another aspect, a computing device is further provided, including a memory and a processor, where the memory stores executable code, and when executing the executable code, the processor implements the method described with reference to FIG. 2 or FIG. 3.

The embodiments of this specification are described in a progressive way. For same or similar parts in the embodiments, references can be made to each other. Each embodiment focuses on a difference from another embodiment. Particularly, the system embodiments are basically similar to the method embodiments, and therefore are described briefly. For related parts, references can be made to related descriptions in the method embodiments.

The methods or the algorithm steps described in the disclosed content of this specification can be implemented by hardware, or can be implemented by executing software instructions by a processor. The software instructions can include corresponding software modules. The software modules can be stored in a RAM memory, a flash memory, a ROM memory, an EPROM memory, an EEPROM memory, a register, a hard disk, a removable hard disk, a CD-ROM, or any other form of storage medium known in the art. An example storage medium is coupled to the processor, so the processor can read information from the storage medium and can write information to the storage medium. Certainly, the storage medium can be a component of the processor. The processor and the storage medium can be located in the ASIC. In addition, the ASIC can be located in a server. Certainly, the processor and the storage medium can alternatively exist in the server as discrete components.

A person skilled in the art should be aware that in the above-mentioned one or more examples, functions described in this specification can be implemented by hardware, software, firmware, or any combination thereof. When implemented by using software, these functions can be stored in a computer-readable medium or transmitted as one or more instructions or one or more pieces of code on a computer-readable medium. The computer-readable medium includes a computer storage medium and a communication medium, where the communication medium includes any medium that enables a computer program to be transmitted from one place to another. The storage medium can be any available medium accessible to a general-purpose or dedicated computer.

Specific embodiments of this specification are described above. Other embodiments fall within the scope of the appended claims. In some cases, the actions or steps described in the claims can be performed in an order different from that in the embodiments, and the desired results can still be achieved. In addition, processes described in the accompanying drawings do not necessarily need a specific order or a sequential order shown to achieve the desired results. In some implementations, multi-tasking and concurrent processing are feasible or can be advantageous.

The objectives, technical solutions, and beneficial effects of this specification are further described in detail in the above-mentioned specific implementations. It should be understood that the above-mentioned descriptions are merely some specific implementations of this specification, but are not intended to limit the protection scope of this specification. Any modification, equivalent replacement, or improvement made based on the technical solutions in this specification shall fall within the protection scope of this specification.

What is claimed is:

1. A method for performing service verification on a plurality of parties in federated computation based on a container cluster, wherein the container cluster comprises a master node and a plurality of slave nodes respectively deployed in a plurality of participants, and the method comprises:
sending, by a verification management center, a task establishment request to the master node in response to a service verification request of a user, wherein the task establishment request indicates at least a target service that is to be verified and that is used by a target participant;
creating, by the master node, a verification task of the target service for a target slave node in the target participant based on the task establishment request;
verifying, by the target slave node, a target service of the target participant in response to the verification task, to obtain a service verification result; and
providing, by the target slave node, the service verification result for the verification management center.

2. The method according to claim 1, wherein the task establishment request indicates at least a unique identifier of data to be verified; and
the creating a verification task of the target service for a target slave node in the target participant comprises:
adding the unique identifier of the data to be verified to a configuration parameter of the verification task as a verification basis.

3. The method according to claim 1, wherein the verifying, by the target slave node, a target service of the target participant in response to the verification task comprises:
listening for, by a container management component in the target slave node, the verification task, and when obtaining the verification task through listening, starting a verification module in the target slave node, and verifying the target service by using the verification module.

4. The method according to claim 3, wherein the verifying the target service by using the verification module comprises:
invoking an interface of the target service by using the verification module, to obtain a verification result of data to be verified; and
upon determining that the verification result satisfies a predetermined condition, determining that the service verification result is a verification success.

5. The method according to claim 4, wherein the verification result comprises a quantity of fields comprised in the data to be verified and/or data types of at least a part of fields.

6. The method according to claim 4, further comprising:
upon determining that the invoking of the interface of the target service fails, determining that the service verification result is a verification failure; or
upon determining that the verification result does not satisfy the predetermined condition, determining that the service verification result is a verification failure.

7. The method according to claim 1, after the sending a task establishment request to the master node, further comprising:
initializing, by the verification management center, a task state of the verification task; and
updating, by the verification management center, the task state based on the service verification result after receiving the service verification result.

8. The method according to claim 7, wherein before the providing, by the target slave node, the service verification result for the verification management center, the method further comprises:
receiving, by the verification management center, a task start notification sent by the target slave node after starting to verify the target service; and
updating, by the verification management center, the initialized task state based on the task start notification to obtain an intermediate state; and
the updating the task state based on the service verification result comprises:
updating the intermediate state based on the service verification result.

9. The method according to claim 7, after the initializing, by the verification management center, a task state of the verification task, further comprising:
upon determining that that the service verification result is not received after a timeout time threshold is reached, updating, by the verification management center, the task state to a failure.

10. The method according to claim 1, wherein the target service comprises at least one of a storage service, an audit service, and a preprocessing service of local feature data.

11. A system for performing service verification on a plurality of parties in federated computation based on a container cluster, wherein the system comprises a verification management center and a container cluster, and the container cluster comprises a master node and a plurality of slave nodes respectively deployed in a plurality of participants, wherein
the verification management center is configured to send a task establishment request to the master node in response to a service verification request of a user, wherein the task establishment request indicates at least a target service that is to be verified and that is used by a target participant;
the master node is configured to create a verification task of the target service for a target slave node in the target participant based on the task establishment request;
the target slave node is configured to verify a target service of the target participant in response to the verification task, to obtain a service verification result; and
the target slave node is further configured to provide the service verification result for the verification management center.

12. The system according to claim 11, wherein the task establishment request indicates at least a unique identifier of data to be verified; and
the master node is specifically configured to:
add the unique identifier of the data to be verified to a configuration parameter of the verification task as a verification basis.

13. The system according to claim 11, wherein the target slave node is specifically configured to:
listen for, by a container management component in the target slave node, the verification task, and when obtaining the verification task through listening, start a verification module in the target slave node, and verify the target service by using the verification module.

14. The system according to claim 13, wherein the target slave node is further specifically configured to:
invoke an interface of the target service by using the verification module, to obtain a verification result of data to be verified; and
upon determining that the verification result satisfies a predetermined condition, determine that the service verification result is a verification success.

15. The system according to claim 14, wherein the verification result comprises a quantity of fields comprised in the data to be verified and/or data types of at least a part of fields.

16. (canceled)

17. The system according to claim 11, wherein
the verification management center is further configured to initialize a task state of the verification task; and
the verification management center is further configured to update the task state based on the service verification result after receiving the service verification result.

18. The system according to claim 17, wherein
the verification management center is further configured to receive a task start notification sent by the target slave node after starting to verify the target service;
the verification management center is further configured to update the initialized task state based on the task start notification to obtain an intermediate state; and
the verification management center is specifically configured to:
update the intermediate state based on the service verification result.

19. The system according to claim 17, wherein
the verification management center is further configured to: upon determining that the service verification result is not received after a timeout time threshold is reached, update the task state to a failure.

20. The system according to claim 11, wherein the target service comprises at least one of a storage service, an audit service, and a preprocessing service of local feature data.

21. A non-transitory computer-readable storage medium, wherein comprising instructions stored therein that, when executed by a processor of a computing device, cause the processor to:
send, by a verification management center, a task establishment request to a master node of a container cluster in response to a service verification request of a user, wherein the task establishment request indicates at least a target service that is to be verified and that is used by a target participant;
create, by the master node, a verification task of the target service for a target slave node in the target participant based on the task establishment request;
verify, by the target slave node, a target service of the target participant in response to the verification task, to obtain a service verification result; and
provide, by the target slave node, the service verification result for the verification management center.

22. (canceled)
